(19) United States
(12) Patent Application Publication
(10) Pub. No.: US 2020/0302419 A1
(43) Pub. Date: Sep. 24, 2020

(54) INFORMATION PROCESSING APPARATUS AND METHOD

(71) Applicant: TOSHIBA TEC KABUSHIKI KAISHA, Tokyo (JP)

(72) Inventor: Takashi MURAOKA, Sunto Shizuoka (JP)

(73) Assignee: TOSHIBA TEC KABUSHIKI KAISHA, Tokyo (JP)

(21) Appl. No.: 16/705,992

(22) Filed: Dec. 6, 2019

(30) Foreign Application Priority Data
Mar. 22, 2019 (JP) 2019-055196

(51) Int. Cl. G06Q 20/20; G07G 1/12; G07G 1/00

(52) U.S. Cl. CPC G06Q 20/208; G06Q 20/209; G07G 1/0072; G07G 1/0063; G07G 1/12

(57) ABSTRACT

According to one embodiment, an information processing apparatus executes sales registration processing of a commodity to be purchased. The apparatus includes a print information output unit configured to output first print information for a shop to a first printer regarding the sales registration processing such that the first printer prints the first print information for a shop; and configured to output second print information for a customer regarding the sales registration processing to a second printer such that the second printer prints the second print information for a customer.

### CROSS-REFERENCE TO RELATED APPLICATION

This application is based upon and claims the benefit of priority from Japanese Patent Application No. 2019-055196, filed in Mar. 22, 2019, the entire contents of which are incorporated herein by reference.

### FIELD

Embodiments described herein relate generally to an information processing apparatus and a method.

### BACKGROUND

In the related art, in an information processing apparatus such as a Point of Sales (POS) terminal that is used for commodity sales in a shop such as a convenience store, printed matters, for example, a receipt on which commodity information or settlement information of purchased commodities is printed or a credit slip for the use of a credit card is printed by a printer and dispensed to a customer who purchased the commodities.

However, these printed matters include a copy for a customer and a copy for a shop. For example, disclosed is an electronic cash register that prints a receipt for a customer and a journal for a shop using two printers, respectively, and dispenses the receipt and the journal to a clerk side. In this case, it is necessary for the clerk to receive the receipt for the customer, as printed and dispensed by the printer, and to give the receipt to the customer.

Therefore, recently, disclosed is a POS terminal including a printer that directly dispenses a receipt for a customer to the customer. For example, disclosed is a POS terminal that includes a printer that can be rotated such that a direction of the dispensing port changes between a clerk side and a customer side, in which the printer is rotated to the customer side to dispense a receipt such that the customer itself can receive the receipt.

However, when it is forgotten to rotate the printer to the customer side, there may be a case where a receipt to be received by a customer cannot be dispensed to the customer side.

### DESCRIPTION OF THE DRAWINGS

FIG. 1 is a block diagram illustrating a hardware configuration of a POS terminal according to an embodiment;

FIG. 2 is a diagram illustrating a configuration of a printer information unit;

FIG. 3 is a functional block diagram illustrating a functional configuration of the POS terminal;

FIG. 4 is a flowchart illustrating the flow of a control process of the POS terminal; and

FIG. 5 is a flowchart illustrating the flow of a control process of a modification example of the POS terminal.

### DETAILED DESCRIPTION

Embodiments provide an information processing apparatus capable of reliably dispensing a printed matter that is printed by a printer and is to be received by a customer to a customer side and a method.

In general according to one embodiment, an information processing apparatus executes sales registration processing of a commodity to be purchased. The apparatus includes a print information output unit configured to output first print information for a shop to a first printer regarding the sales registration processing such that the first printer prints the first print information for a shop; and configured to output second print information for a customer regarding the sales registration processing to a second printer such that the second printer prints the second print information for a customer.

Hereinafter, an information processing apparatus and a method according to an embodiment will be described. In the embodiment a Point of Sales (POS) terminal will be described as an example of the information processing apparatus. In addition, in the embodiment, a face-to-face self-service checkout POS terminal (hereinafter, simply referred to as “POS terminal”) will be described as an example, in which a shop clerk executes a sales registration operation relating to commodities to sell and a customer executes a settlement operation of commodities on which the sales registration processing is executed. In addition, in the following description, the side where a clerk is positioned with respect to the POS terminal will be referred to as “clerk side”, and the side where a customer is positioned with respect to the POS terminal will be referred to as “customer side”. The exemplary embodiment is not limited to an embodiment described below.

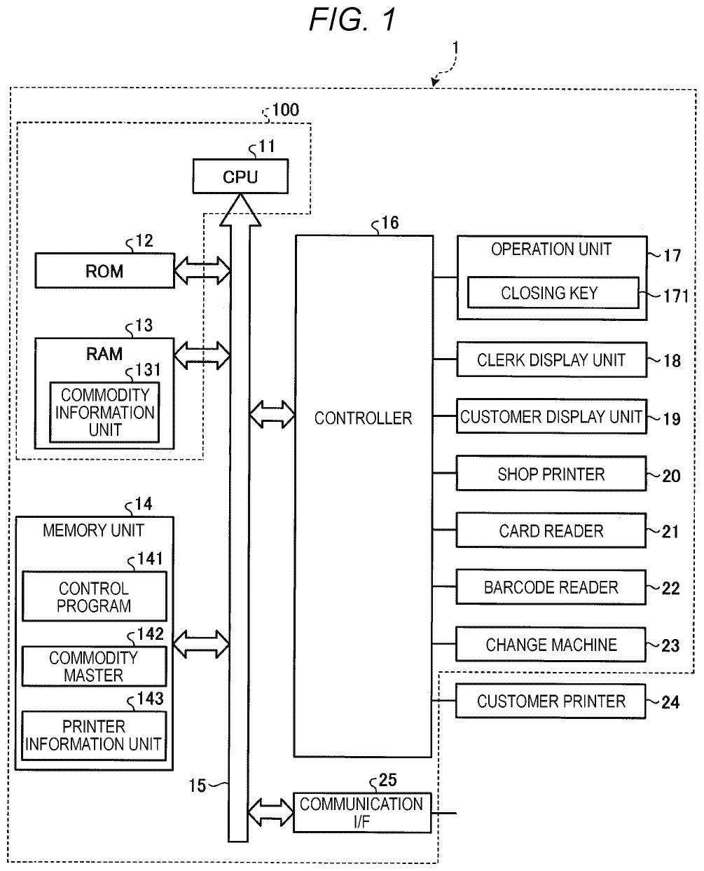

First, hardware of a POS terminal 1 will be described. FIG. 1 is a block diagram illustrating a hardware configuration of the POS terminal 1. As illustrated in FIG. 1, for example, the POS terminal 1 includes a CPU (Central Processing unit) 11, a ROM (Read Only Memory) 12, a RAM (Random Access Memory) 13, and a memory unit 14. The CPU 11 is a main controller. The ROM 12 stores various programs. The RAM 13 loads various data. The memory unit 14 stores various programs. The CPU 11, the ROM 12, the RAM 13, and the memory unit 14 are connected to each other via a data bus 15. The CPU 11, the ROM 12, and the RAM 13 configure a control unit 100. That is, the control unit 100 executes a control process of the POS terminal 1 described below by the CPU 11 operating in accordance with a control program that is stored in the ROM 12 or the memory unit 14 and is loaded to the RAM 13.

The RAM 13 includes a commodity information unit 131. The commodity information unit 131 stores commodity information (for example, commodity name or price) of commodities on which the sales registration processing is executed by the POS terminal 1. The sales registration processing includes a process of displaying commodity information such as a name or a price of a commodity corresponding to a commodity code for specifying the commodity on a clerk display unit 18 and a customer display unit 19 of the POS terminal and storing the commodity information in the commodity information unit 131, the commodity code being acquired by reading a symbol attached to the commodity.

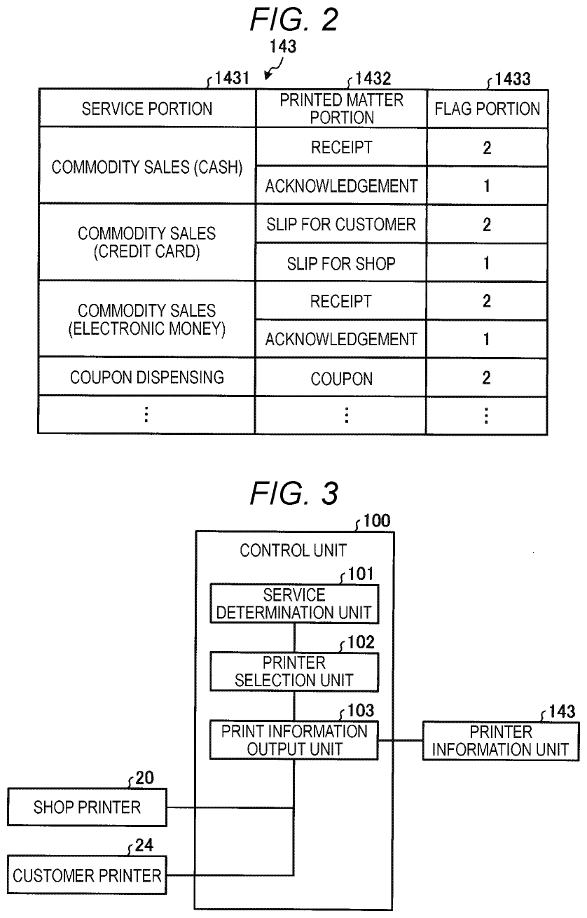

The memory unit 14 includes a control program unit 141, a commodity master 142, and a printer information unit 143. The control program unit 141 stores a program for controlling the POS terminal 1. The commodity master 142 stores the commodity information of the commodity in association with the commodity code for specifying the commodity. The printer information unit 143 will be described below using FIG. 2.

In addition, the control unit 100 is connected to an operation unit 17, the clerk display unit 18, the customer display unit 19, a shop printer 20 (first printer), a card reader 21, a barcode reader 22, and a change machine 23 via the data bus 15 and a controller 16. In addition, the control unit 100 includes a customer printer 24 (second printer) via the data bus 15 and the controller 16.

The clerk display unit 18 is, for example, a liquid crystal display and displays information to a clerk. The customer display unit 19 is, for example, a liquid crystal display and displays information to a customer. The clerk display unit 18 includes an operation unit 17 that is a touch panel keyboard including a closing key 171. The closing key 171 is operated to end the sales registration processing of commodities and to start settlement processing. In addition, the customer display unit 19 is the touch panel operation unit 17.

In the embodiment, the shop printer 20 is a printer that is embedded in the POS terminal 1. The shop printer 20 dispenses a printed matter from a dispensing port (not illustrated) provided in the POS terminal 1, the printed matter being stored in a shop, for example, a slip for a shop that is printed on a receipt sheet. In addition, the shop printer 20 prints the printed matter that is given to the customer by the clerk through some sort of processes. For example, an acknowledgement is printed and dispensed by the shop printer 20 because it is given to the customer after putting a stamp of a shop on the acknowledgement. The printed matter dispensed from the shop printer 20 is dispensed to the side where the clerk is positioned. Therefore, the clerk can directly receive the printed matter dispensed from the shop printer 20. In addition, in the embodiment, the customer printer 24 is an external printer that is connected to a port provided in the controller 16 of the POS terminal 1. The customer printer 24 includes a dispensing port (not illustrated) of a printed matter and dispenses a printed matter for a customer such as a receipt or a slip printed on a receipt sheet. The printed matter dispensed from the customer printer 24 is dispensed to the side where the customer is positioned. Therefore, the customer can directly receive the printed matter dispensed from the customer printer 24.

For example, the card reader 21 reads information from a medium such as a credit card. The POS terminal 1 executes settlement processing for the customer based on the read information.

The barcode reader 22 optically reads a symbol such as a barcode or a two-dimensional code attached to a commodity. The barcode reader 22 reads the symbol by allowing reflected light from a symbol that emits light by itself or reflected light of natural light from a symbol to be incident thereinto. The barcode reader 22 may have a structure where the symbol is read based on an image obtained by imaging the symbol.

The change machine 23 includes a coin change machine and a bill change machine (both of which are not illustrated) . The coin change machine includes a coin insertion port. The coin insertion port is a port into which coins of the price paid by the customer are inserted. The coin insertion port is provided on the customer side. In addition, the coin change machine includes a coin tray. The coin tray receives coins discharged to the customer as change. The coin tray is provided on the customer side such that the discharged coins can be directly received by the customer. The bill change machine includes a bill insertion port. The bill insertion port is a port into which bills of the price paid by the customer are inserted. The bill insertion port is provided on the customer side. In addition, the bill change machine includes a bill reception portion that receives bills discharged as change. The bill reception portion is provided on the customer side such that the discharged bills can be directly received by the customer.

In addition, the control unit 100 is connected to a communication I/F 25 via the data bus 15. The communication I/F 25 is connected to a shop server or another POS terminal 1 provided in the shop via a network such as a LAN (Local Area Network), and receives and transmits information between the components.

The customer puts commodities to be purchased into a basket for shopping in the shop. The customer places the commodities put into the basket on a table provided near the POS terminal 1. The clerk extracts the commodities from the basket and holds the commodities up over the barcode reader 22 of the POS terminal 1 to execute the sales registration operation of allowing symbols such as barcodes or two-dimensional codes attached to the commodities to be read by the POS terminal 1. The POS terminal 1 executes the sales registration processing relating to the commodities based on the read symbols. The sales registration processing includes processes of reading commodity information (names or prices of the commodities) of the commodities from the commodity master 142 based on the read symbols, displaying the commodity information on the clerk display unit 18 and the customer display unit 19, and storing the commodity information in the commodity information unit 131, the commodity information corresponding to commodity codes for specifying the commodities associated with the commodities.

When the closing key 171 is operated by the clerk, the sales registration processing by the POS terminal 1 ends and transitions to the settlement processing. The customer checks the displayed total sum and inserts money from a coin insertion portion or a bill insertion portion. As a result, the POS terminal 1 executes the settlement processing relating to the transaction based on the commodity information of the commodities on which the sales registration processing is executed. The settlement processing includes processes of calculating the amount of change based on the total sum of the commodities on which the sales registration processing is executed and the amount of money paid by the customer and displaying the amount of change on the clerk display unit 18 and the customer display unit 19. In addition, in the settlement processing, the POS terminal discharges money corresponding to the amount of change from the change machine 23 to the coin tray or the bill reception portion provided on the customer side as change. The customer directly receives the discharged change. For example, the clerk packs the commodities while the customer pays the money.

Next, the printer information unit 143 will be described. FIG. 2 is a diagram illustrating a configuration of the printer information unit. The printer information unit 143 is a table including information representing whether a printed matter is dispensed from the shop printer 20 or the customer printer 24 based on a service per service where a process is executed by the POS terminal 1. The printer information unit 143 includes a service portion 1431, a printed matter portion 1432, and a flag portion 1433.

The service portion 1431 stores the service where a process is executed by the POS terminal 1. In the example of FIG. 2, services of commodity sales (cash), commodity sales (credit card), commodity sales (electronic money), and coupon dispensing are described as examples of the service where a process is executed by the POS terminal 1. Actually, the POS terminal 1 executes more services.

The printed matter portion 1432 stores a printed matter that is printed on a receipt sheet and dispensed per each of the services. In the example illustrated in FIG. 2, a receipt and an acknowledgement are stored as printed matters associated with the service of the commodity sales (cash). That is, in the service of the commodity sales (cash), a receipt and an acknowledgement are printed and dispensed as printed matters. In addition, in the example of FIG. 2, a slip for a customer and a slip for a shop are stored as printed matters associated with the service of the commodity sales (credit card). That is, in the service of the commodity sales (credit card), a slip for a customer and a slip for a shop are printed and dispensed as printed matters. In addition, in the example illustrated in FIG. 2, a receipt and an acknowledgement are stored as printed matters associated with the service of the commodity sales (electronic money). That is, in the service of the commodity sales (electronic money), a receipt and an acknowledgement are printed and dispensed as printed matters. In addition, in the example of FIG. 2, a coupon is stored as a printed matter associated with the service of coupon dispensing. That is, in the service of coupon dispensing, a coupon is printed and dispensed as a printed matter. Information printed on the printed matter is print information.

The flag portion 1433 stores a number (flag) of a printer that prints and dispenses each of the printed matters. When the flag is “1”, the printed matter is printed and dispensed by the shop printer 20. When the flag is “2”, the printed matter is printed and dispensed by the customer printer 24.

In the example of FIG. 2, when a receipt is dispensed in the service of commodity sales (cash), the flag is “2”. Therefore, the receipt is printed and dispensed by the customer printer 24. Thus, the receipt dispensed in the service of commodity sales (cash) is directly received by the customer. In addition, in the example of FIG. 2, when an acknowledgement is dispensed in the service of commodity sales (cash), the flag is “1”. Therefore, the acknowledgement is printed and dispensed by the shop printer 20. Thus, the acknowledgement dispensed in the service of commodity sales (cash) is directly received by the clerk. The clerk puts a stamp on the received acknowledgement and gives the acknowledgement to the customer.

In addition, in the example of FIG. 2, when a slip for a customer is dispensed in the service of commodity sales (credit card), the flag is “2”. Therefore, the slip for a customer is printed and dispensed by the customer printer 24. Thus, the acknowledgement dispensed in the service of commodity sales (credit card) is directly received by the customer. In addition, when a slip for a shop is dispensed in the service of commodity sales (credit card), the flag is “1”. Therefore, the slip for a shop is printed and dispensed by the shop printer 20. Thus, the slip for a shop dispensed in the service of commodity sales (credit card) is directly received by the clerk. The clerk receives a signature of the customer on the received slip for a shop and stores the slip for a shop in the shop.

In addition, in the example of FIG. 2, when a receipt is dispensed in the service of commodity sales (electronic money), the flag is “2”. Therefore, the receipt is printed and dispensed by the customer printer 24. Thus, the receipt dispensed in the service of commodity sales (electronic money) is directly received by the customer. In addition, in the example of FIG. 2, when an acknowledgement is dispensed in the service of commodity sales (electronic money) , the flag is “1”. Therefore, the acknowledgement is printed and dispensed by the shop printer 20. Thus, the acknowledgement dispensed in the service of commodity sales (electronic money) is directly received by the clerk. The clerk puts a stamp on the received acknowledgement and gives the acknowledgement to the customer.

In addition, in the example of FIG. 2, when a coupon is dispensed in the service of coupon dispensing, the flag is “2”. Therefore, the coupon is printed and dispensed by the customer printer 24. Thus, the coupon dispensed in the service of coupon dispensing is directly received by the customer.

Hereinafter, a functional configuration of the POS terminal 1 will be described. FIG. 3 is a functional block diagram illustrating the functional configuration of the POS terminal 1. As illustrated in FIG. 3, the control unit 100 of the POS terminal 1 functions as at least one of a service determination unit 101, a printer selection unit 102, or a print information output unit 103 by operating in accordance with the control program stored in the ROM 12 or the memory unit 14 and loaded to the RAM 13.

The service determination unit 101 determines a service that is currently being executed by the POS terminal 1. In the embodiment, for example, when a current total key (not illustrated) for cash settlement is operated, the service determination unit determines that the service of commodity sales (cash) is being executed. In addition, when a credit key is operated, the service determination unit determines that the service of the commodity sales (credit card) is being executed. In addition, when an electronic money key is operated, the service determination unit determines that the service of the commodity sales (electronic money) is being executed. In addition, when a coupon dispensing key is operated, the service determination unit determines that the service of coupon dispensing is being executed. The service may be determined based on an operation other than the key operation.

The printer selection unit 102 selects a printer that prints a printed matter based on the service that is being currently being executed by the POS terminal 1. Specifically, the printer selection unit 102 searches the printer information unit 143 based on the service that is being currently executed by the POS terminal 1 and selects a printer that prints a printed matter in the service.

For example, when the service of commodity sales (cash) is executed and a receipt is printed and dispensed as the printed matter, the printer selection unit 102 searches the printer information unit 143 and selects the customer printer 24 based on flag information stored in the flag portion 1433 associated with the receipt of the service of commodity sales (cash). In addition, when the service of commodity sales (cash) is executed and an acknowledgement is printed and dispensed as the printed matter (it can be seen that the acknowledgement is dispensed because an acknowledgement key is operated), the printer selection unit 102 searches the printer information unit 143 and selects the shop printer 20 based on the flag information stored in the flag portion 1433 associated with the acknowledgement of the service of commodity sales (cash).

In addition, when the service of commodity sales (credit card) is executed and a slip for a customer and a slip for a shop are dispensed as the printed matters, the printer selection unit 102 selects the customer printer 24 in a case where the slip for a customer is printed and selects the shop printer 20 in a case where the slip for a shop is printed.

In addition, for example, when the service of commodity sales (electronic money) is executed and a receipt is printed and dispensed as the printed matter, the printer selection unit 102 searches the printer information unit 143 and selects the customer printer 24 based on flag information stored in the flag portion 1433 associated with the receipt of the service of commodity sales (electronic money). In addition, when the service of commodity sales (electronic money) is executed and an acknowledgement is printed and dispensed as the printed matter, the printer selection unit 102 searches the printer information unit 143 and selects the shop printer 20 based on the flag information stored in the flag portion 1433 associated with the acknowledgement of the service of commodity sales (electronic money).

In addition, for example, when the service of coupon dispensing is executed, the printer selection unit 102 searches the printer information unit 143 and selects the customer printer 24 based on flag information stored in the flag portion 1433 associated with the receipt of the service of coupon dispensing.

In addition, the printer selection unit 102 searches the printer information unit 143 and determines whether or not the selected printer is usable. For example, when the selected printer is on-line, the printer selection unit 102 determines that the printer is usable. On the other hand, when the selected printer is off-line, the printer selection unit 102 determines that the printer is not usable. For example, when the selected printer is broken, when the selected printer is not loaded with a receipt sheet, or when the receipt sheet is used up, the printer is off-line.

When the customer printer 24 is not usable, the printer selection unit 102 selects the shop printer 20 instead. In addition, when the shop printer 20 is not usable, the printer selection unit 102 displays an error message on the clerk display unit 18 and the customer display unit 19 without selecting the customer printer 24 instead, the error message representing that the printed matter cannot be printed by the shop printer 20.

When the customer printer 24 is not usable, information to be printed by the customer printer 24 can be printed by the shop printer 20 without any problem. For example, a receipt to be given to the customer may be dispensed by the shop printer 20 such that the receipt is given to the customer by the clerk. However, when the shop printer 20 is not usable, information to be printed by the shop printer 20 can be printed by the customer printer 24 without any problem. To the customer, it is not desirable to dispense an unnecessary printed matter to the customer side. Therefore, when the shop printer 20 is not usable, the printer selection unit 102 does not select the customer printer 24. The printer selection unit 102 displays an error message on the clerk display unit 18 and the customer display unit 19, the error message representing that the printed matter cannot be printed by the shop printer 20.

The print information output unit 103 outputs print information for a shop to the shop printer 20 regarding the sales registration processing such that the shop printer 20 prints the print information for a shop. Specifically, when the printer selection unit 102 searches the printer information unit 143 and selects the shop printer 20, the print information output unit 103 adds unique information for specifying the shop printer 20 to the beginning (for example, a header) of print data to be printed by the shop printer 20 and outputs the print data. More specifically, the print information output unit 103 adds the unique information for specifying the shop printer 20 to the print data and outputs the print data to the controller 16. The controller 16 transmits the print data to the shop printer 20 based on the unique information for specifying the shop printer 20 that is added to the beginning of the print data. The shop printer 20 executes printing based on the received print data and dispenses a printed matter.

In addition, the print information output unit 103 outputs print information for a customer regarding the sales registration processing to the customer printer 24 such that the customer printer 24 prints the print information for a customer. Specifically, when the printer selection unit 102 searches the printer information unit 143 and selects the customer printer 24, the print information output unit 103 adds unique information for specifying the customer printer 24 to the beginning of print data to be printed by the customer printer 24 and outputs the print data. More specifically, the print information output unit 103 adds the unique information for specifying the customer printer 24 to the print data and outputs the print data to the controller 16. The controller 16 transmits the print data to the customer printer 24 based on the unique information for specifying the customer printer 24 that is added to the beginning of the print data. The customer printer 24 executes printing based on the received print data and dispenses a printed matter.

In addition, when the printer selection unit 102 selects the shop printer 20 because the customer printer 24 is not usable, the print information output unit 103 adds the unique information for specifying the shop printer 20 to the beginning of the print data to be printed by the customer printer 24 and outputs the print data to the controller 16.

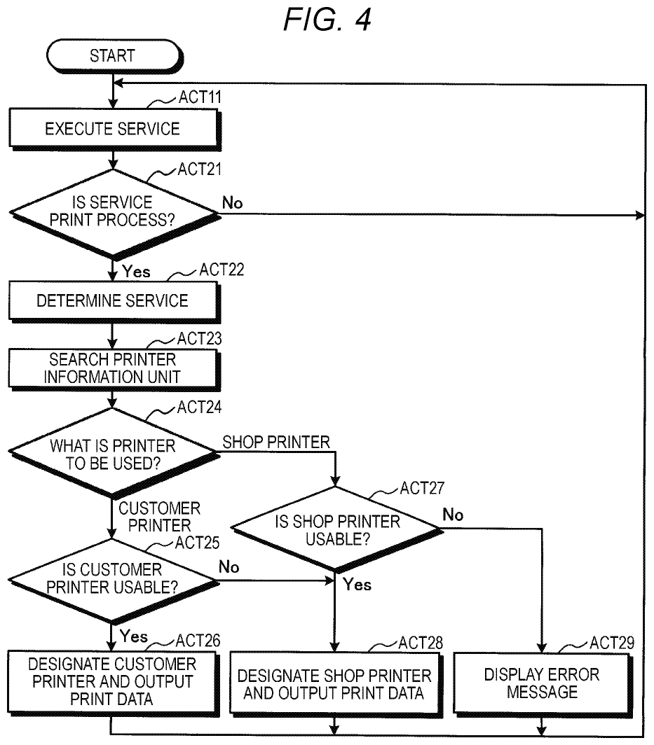

Hereinafter, a control of the POS terminal 1 will be described. FIG. 4 is a flowchart illustrating the flow of a control process of the POS terminal 1. As illustrated in FIG. 4, the control unit 100 of the POS terminal 1 executes a service in accordance with, for example, a key operation (ACT 11). Alternatively, the control unit 100 of the POS terminal 1 executes the service designated in the mode (ACT 11). Next, the control unit 100 determines whether or not the service is a printing process of printing information on a receipt sheet and dispensing a printed matter (ACT 21). When the service determination unit 101 determines that the service is the printing process (Yes in ACT 21), the service determination unit 101 determines the service that is currently being executed by the POS terminal 1 (ACT 22). The printer selection unit 102 searches the printer information unit 143 based on the service that is currently being executed by the POS terminal 1 (ACT 23). The printer selection unit 102 selects the printer that prints the printed matter, determines whether or not each of the printers is usable, and determines a destination to which the print data is output.

Specifically, the printer selection unit 102 searches the printer information unit 143 and determines whether the printer to be used is the shop printer 20 or the customer printer 24 (ACT 24). When the printer selection unit 102 determines that the printer to be used is the customer printer 24, the printer selection unit 102 determines whether or not the customer printer 24 is usable (ACT 25). When the printer selection unit 102 determines that the customer printer 24 is usable (Yes in ACT 25), the print information output unit 103 designates the customer printer 24 and outputs the print data to the controller 16 (ACT 26). Specifically, the print information output unit 103 adds the unique information for specifying the customer printer 24 to the beginning of the print data and outputs the print data to the controller 16 (ACT 26). Next, the control unit 100 returns to ACT 11. The customer printer 24 receives the print data and prints and dispenses the printed matter.

In addition, when the printer selection unit 102 determines that the printer to be used is the shop printer 20, the printer selection unit 102 determines whether or not the shop printer 20 is usable (ACT 27). When the printer selection unit 102 determines that the shop printer 20 is usable (Yes in ACT 27), the print information output unit 103 designates the shop printer 20 and outputs the print data to the controller 16 (ACT 28). Specifically, the print information output unit 103 adds the unique information for specifying the shop printer 20 to the beginning of the print data and outputs the print data to the controller 16 (ACT 28). Next, the control unit 100 returns to ACT 11. The shop printer 20 receives the print data and prints and dispenses the printed matter.

In addition, when the printer selection unit 102 determines that the shop printer 20 is not usable (No in ACT 27), the printer selection unit 102 displays an error message on the clerk display unit 18 and the customer display unit 19, the error message representing that the printed matter cannot be printed by the shop printer 20 (ACT 29). Next, the control unit 100 returns to ACT 11.

In addition, when the printer selection unit 102 determines that the customer printer 24 is not usable (No in ACT 25), the print information output unit 103 designates the shop printer 20 instead of the customer printer 24 and outputs the print data to the controller 16 (ACT 28). Specifically, the print information output unit 103 adds the unique information for specifying the shop printer 20 to the beginning of the print data to be printed by the customer printer 24 and outputs the print data to the controller 16 (ACT 28). Next, the control unit 100 returns to ACT 11. The shop printer 20 receives the print data and prints and dispenses the printed matter. When the service determination unit 101 determines that the service is not the printing process in ACT 21 (No in ACT 21), the control unit 100 returns to ACT 11.

According to the embodiment, the printed matter that is printed by the customer printer 24 and is to be received by the customer can be reliably dispensed to the customer side. In addition, when the customer printer 24 is not usable, the printed matter to be printed by the customer printer 24 can be printed and dispensed using the shop printer 20.

Hereinafter, a modification example of the embodiment will be described. In the embodiment, when the shop printer 20 is not usable, the error message is displayed. However, in a modification example, when the shop printer 20 is not usable, the printed matter for a shop may be printed by the customer printer 24. The other configurations of the modification example are the same as those of the embodiment. In the modification example, the same components as those of the embodiment are represented by the same reference numerals, and the description thereof will not be repeated.

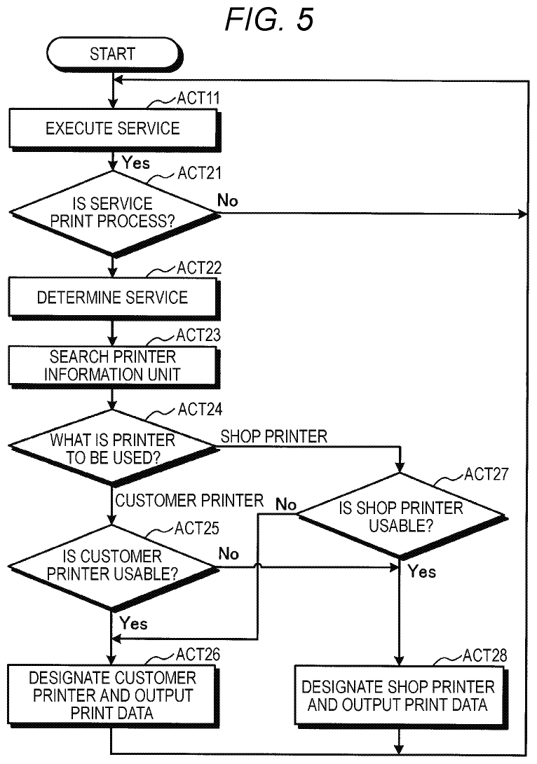

FIG. 5 is a flowchart illustrating the flow of a control process of the modification example of the POS terminal 1. As illustrated in FIG. 5, when the printer to be used is the shop printer 20 (the shop printer is selected in ACT 24) and the printer selection unit 102 determines that the shop printer 20 is not usable (No in ACT 27), the print information output unit 103 adds the unique information for specifying the customer printer 24 to the beginning of the print data to be printed by the shop printer 20 and outputs the print data to the controller 16 (ACT 26).

According to the modification example, the printed matter that is printed by the customer printer 24 and is to be received by the customer can be reliably dispensed to the customer side. In addition, when the customer printer 24 is not usable, the printed matter to be printed by the customer printer 24 can be printed and dispensed using the shop printer 20. In addition, when the shop printer 20 is not usable, the printed matter to be printed by the shop printer 20 can be printed and dispensed using the customer printer 24.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the description of the embodiment, the shop printer 20 is a printer that is embedded in the POS terminal 1, and the customer printer 24 is an external printer that is connected to the POS terminal 1. However, the embodiment is not limited to this configuration. The shop printer 20 may be an external printer that is connected to the POS terminal 1, and the customer printer 24 may be a printer that is embedded in the POS terminal 1. In addition, the shop printer 20 and the customer printer 24 may be printers that are embedded in the POS terminal 1. In addition, the shop printer 20 and the customer printer 24 may be external printers that are connected to the POS terminal 1.

In addition, in the embodiment, the print information output unit 103 adds the unique information for specifying the shop printer 20 or the customer printer 24 to the beginning of the print data, outputs the print data to the controller 16, and automatically prints and dispenses the print data using either the shop printer 20 or the customer printer 24. However, the embodiment is not limited to this configuration. For example, the information processing apparatus may include a designation unit (for example, a first key that causes the shop printer 20 to execute printing and a second key that causes the customer printer 24 to execute printing) that designates the printer that prints the print matter when the printed matter is printed. As a result, for example, when the clerk operates the first key, the printed matter is printed by the shop printer 20 and is dispensed to the shop side. In addition, for example, when the clerk operates the second key, the printed matter is printed by the customer printer 24 and is dispensed to the customer side.

In addition, in the embodiment, the printer that prints the printed matter relating to the service is provided in the form of a table of the printer information unit 143. However, the embodiment is not limited to this configuration. For example, for a program that executes a process of each of the services, the printer that prints the printed matter related to the service may be designated.

In addition, in the embodiment, the face-to-face self-service checkout POS terminal 1 has been described as an example of the information processing apparatus. However, the embodiment is not limited to this configuration. For example, a POS terminal that allows the clerk to execute all the operations or a commodity registration apparatus of a self-service checkout POS terminal including a commodity registration apparatus and a checkout apparatus may be used as the information processing apparatus.

In addition, in the embodiment, the shop printer 20 dispenses the printed matter to the side where the clerk is positioned, and the customer printer 24 dispenses the printed matter to the side where the customer is positioned. However, the embodiment is not limited to this configuration. The shop printer 20 may dispense the printed matter such that the printed matter can be directly received by the clerk, and the customer printer 24 may dispense the printed matter such that the printed matter can be directly received by the customer.

In addition, in the embodiment, the two printers including the shop printer 20 and the customer printer 24 are used, a printed matter for a shop is printed and dispensed using the shop printer 20, and a printed matter for a customer is printed and dispensed using the customer printer 24. However, the embodiment is not limited to this configuration. One printer may be provided, and printed matter dispensing ports maybe provided on the customer side (customer side dispensing port) and the clerk side (shop side dispensing port), respectively. As a result, the printed matter for a customer is printed by the printer and dispensed from the customer side dispensing port, and the printed matter for a shop is printed by the printer and dispensed from the shop side dispensing port. In this case, a switching unit that switches between a path to the customer side dispensing port and a path to the shop side dispensing port is provided halfway a path through which the printed matter printed by the printer is being transported. As a result, when the printed matter for a customer printed by the printer is dispensed from the customer side dispensing port, the switching unit is operated to block the path to the shop side dispensing port, and the printed matter is transported to the customer side dispensing port through the path from the printer to the customer side dispensing port. In addition, when the printed matter for a shop printed by the printer is dispensed from the shop side dispensing port, the switching unit is operated to block the path to the customer side dispensing port, and the printed matter is transported to the shop side dispensing port through the path from the printer to the shop side dispensing port. When the printed matter for a customer is dispensed, information for blocking the path to the shop side dispensing port is added to the beginning of print data to be output to the printer, and the switching unit switches the path. When the printed matter for a shop is dispensed, information for blocking the path to the customer side dispensing port is added to the beginning of print data to be output to the printer, and the switching unit switches the path.

In this case, the claim is supplemented

### [Supplementary]

1. An information processing apparatus as a commodity registration apparatus that executes sales registration processing of a commodity to be purchased, the apparatus comprising:
a dispensing port for a customer from which a printed matter on which print information for a shop is printed by a printer is dispensed to a customer side regarding the sales registration processing;
a dispensing port for a shop from which a printed matter on which print information for a customer is printed by the printer is dispensed to an operator side where the commodity registration apparatus is operated by an operator regarding the sales registration processing; and
a switching unit configured to switch between a path for dispensing the printed matter to the dispensing port for a customer and a path for dispersing the printed matter to a dispensing port for a shop.

The program that is executed by the information processing apparatus according to the embodiment may be provided by being recorded in a computer-readable recording medium such as a CD-ROM, a flexible disk (FD), a CD-R, or a DVD (Digital Versatile Disk) in a file format that is installable or executable in the controller 40.

In addition, the program that is executed by the information processing apparatus according to the embodiment maybe provided by storing the program in a computer connected to a network such as the Internet and downloading the program through the network. In addition, the program that is executed by the information processing apparatus according to the embodiment may be provided or distributed through a network such as the Internet.

In addition, the program that is executed by the information processing apparatus according to the embodiment may be provided by incorporating the program into a ROM or the like in advance.

What is claimed is:

1. An information processing apparatus that executes sales registration processing of a commodity to be purchased, the apparatus comprising:
a print information output unit configured to:
output, to a first printer, first print information for a shop regarding the sales registration processing such that the first printer prints the first print information for a shop;
output, to a second printer, second print information for a customer regarding the sales registration processing such that the second printer prints the second print information for a customer.

2. The apparatus according to claim 1, wherein
when the second printer is not usable, the print information output unit outputs the second print information for a customer to the first printer; and
when the first printer is not usable, the print information output unit does not output the first print information for a shop to the second printer.

3. The apparatus according to claim 1, wherein
when the second printer is not usable, the print information output unit is configured to output the second print information for a customer to the first printer; and
when the first printer is not usable, the print information output unit is configured to output the first print information for a shop to the second printer.

4. The apparatus according to claim 1, wherein
the second printer is a printer connected to the information processing apparatus; and
the first printer is a printer embedded in the information processing apparatus.

5. The apparatus according to claim 1, wherein the apparatus is a sales data processing apparatus that executes the sales registration processing and settlement processing of a commodity on which the sales registration processing is executed.

6. A method of executing sales registration processing of a commodity to be purchased, the method comprising:
outputting, to a first printer, first print information for a shop regarding the sales registration processing such that the first printer prints the first print information for a shop; and
outputting, to a second printer, second print information for a customer regarding the sales registration processing such that the second printer prints the second print information for a customer.

7. The method according to claim 6, further comprising:
outputting the second print information for a customer to the first printer based on determining that the second printer is not usable; and
not outputting the first print information for a shop to the second printer based on determining that the first printer is not usable.

8. The method according to claim 6, further comprising:
outputting the second print information for a customer to the first printer based on determining that the second printer is not usable, and
outputting the first print information for a shop to the second printer based on determining that the first printer is not usable.

9. The method according to claim 6, wherein
the second printer is a printer connected to the information processing apparatus; and
the first printer is a printer embedded in the information processing apparatus.

10. The apparatus according to claim 1, wherein the first print information and the second print information are different from each other.

11. The method according to claim 6, wherein the first print information and the second print information are different from each other.
